(19) United States
(12) Patent Application Publication
(10) Pub. No.: US 2010/0110697 A1
(43) Pub. Date: May 6, 2010

(54) EMITTING DEVICE

(75) Inventors: Yi-Chen Chen, Taipei City (TW); Ching-Feng Hsieh, Taipei City (TW)

Correspondence Address: SCHMEISER, OLSEN & WATTS, 22 CENTURY HILL DRIVE, SUITE 302, LATHAM, NY, 12110, US

(73) Assignee: ASKEY COMPUTER CORP., TAIPEI (TW)

(21) Appl. No.: 12/419,349

(22) Filed: Apr. 7, 2009

(30) Foreign Application Priority Data
Oct. 31, 2008 (TW) 97219472

(51) Int. Cl. F21V 9/08

(52) U.S. Cl. 362/360

(57) ABSTRACT

The present invention provides an emitting device that is applied to a communication product having a casing and a plurality of embedding portions installed at the casing. The emitting device comprises a plurality of emitting portions corresponding to the embedding portions respectively and a plurality of connecting portions, and each connecting portion is coupled between two adjacent emitting portions, and each emitting portion is embedded into each embedding portion and partially exposed from the casing, such that the integrated emitting device can reduce the level of complexity of the conventional assembling process.

### FIELD OF THE INVENTION

The present invention relates to an emitting device, in particular to an emitting device used for communication products.

### BACKGROUND OF THE INVENTION

As wideband network and digital technology advance, communication products such as wireless network access points (AP), mobile phones, personal digital assistants (PDA), and notebook computers with transmitting and receiving functions are developed for providing convenient, efficient and diversified functions and services.

With the communication product such as a wireless network access device as shown in FIGS. 1 to 2b, a user can log on a network from a computer anytime within a specific region.

In the figures, the wireless network access device 1 comprises: a casing 11; a first embedding portion 13, a second embedding portion 15 and a third embedding portion 17 installed at the casing 11; and a power indicator 12, a press button 14, and a signal indicator 16 embedded into the first embedding portion 13, the second embedding portion 15 and the third embedding portion 17 respectively from a surface of the casing 11, such that the power indicator 12, the press button 14 and the signal indicator 16 can be seen from another surface of the casing 11 that they are fixed to the first embedding portion 13, the second embedding portion 15 and the third embedding portion 17 respectively.

In compliance with the requirements of a light, thin, short and compact design of an electronic product, the power indicator 12, the press button 14 and the signal indicator 16 usually come with small dimensions and specific shapes, and thus it is necessary to install the components one by one in an assembling process and align the components at their positions and directions precisely before the assembling process takes place, as a result, the assembling procedure becomes more complicated, and the manufacturing time of a product remained in the production line becomes longer. In other words, it takes more time for the manufacture. Furthermore, the components may be missing easily if a rework is needed. Obviously, the aforementioned prior art has the drawbacks of wasting both time and labor force for the manufacture. Since there are three components to be embedded into the corresponding embedding portions, several sets of molds are required for the injection molding process during the production of these components, and thus incurring a higher cost for the molds.

Therefore, it is an objective of this invention to find a solution to overcome the aforementioned drawbacks of the conventional emitting device.

### SUMMARY OF THE INVENTION

In view of the aforementioned shortcomings of the prior art, the present invention provides an emitting device to reduce the level of complexity of the assembling process.

It is a primary objective of the present invention to provide an emitting device to shorten the assembling time.

Another objective of the present invention is to provide an emitting device to improve the yield rate.

A further objective of the present invention is to provide an emitting device to lower the manufacturing cost.

Another further objective of the present invention is to provide an emitting device to lower the cost of the mold required for the manufacture.

To achieve the aforementioned effects and other effects, the present invention provides an emitting device applied to a communication product, and the communication product comprises a casing and a plurality of embedding portions disposed at the casing, and the emitting device comprises: a plurality of emitting portions corresponding to the embedding portions respectively for embedding each embedding portion and partially exposing each embedding portion from the casing; and a plurality of connecting portions, each being coupled between two adjacent emitting portions.

In the foregoing emitting device, each connecting portion can be a connecting rod selectively and integrally connected to each emitting portion, wherein the first emitting portion, the second emitting portion and the third emitting portion are installed sequentially, and at least one first connecting portion is connected between the first and second emitting portions, and at least one second connecting portion is installed between the second and third emitting portions.

In an embodiment, the present invention comprises two first connecting portions and two second connecting portions, wherein each first connecting portion is disposed separately on both sides of the first and second emitting portions, and each second connecting portion is disposed separately on both sides of the second and third emitting portions, and the first and second connecting portions are partially connected with or separated from each other. In another embodiment, the first emitting portion, the second emitting portion and the third emitting portion are installed sequentially, and a first connecting portion is coupled between the first and second emitting portions, and a second connecting portion is coupled between the second and third emitting portions. The first connecting portion is disposed on a side of the first and second emitting portions, and the second connecting portion is disposed on a side of the second and third emitting portions, and the first connecting portion and the second connecting portion are disposed on different sides of the emitting device respectively. In a further embodiment, the first emitting portion, the second emitting portion and the third emitting portion are installed sequentially, and a first connecting portion is coupled to a side of the first, second and third emitting portions, and a second connecting portion is coupled to another side of the first, second and third emitting portions. In addition, at least one selected from the first emitting portion, the second emitting portion and the third emitting portion is a dual color emitting portion. The emitting device further comprises a stop portion coupled separately to both sides of the second emitting portion.

Compared with the prior art, the emitting device with an integrated design of the present invention is adopted to substitute the conventional emitting device with many installed components in order to simplify the assembling procedure, lower the cost, reduce the level of complexity of the assembling process, decrease the manufacturing time and improve the yield rate. The components of the present invention will not be missing easily when a rework is needed, and thus the cost of the rework and maintenance is reduced. In addition, the present invention comes with the design of a connecting portion for connecting various components, as a result, a simple set of mold for the processing is required, so as to reduce the cost of the molds.

### BRIEF DESCRIPTION OF THE DRAWINGS

FIG. 1 is an exploded view of a prior art;

FIG. 2a is a schematic view of installing the device as depicted in FIG. 1 to a wireless network access device;

FIG. 2b is a schematic view of FIG. 2a viewed from another angle;

FIG. 3 is an exploded view of an emitting device in accordance with a first embodiment of the present invention;

FIG. 4 is a schematic view of installing the emitting device as depicted in FIG. 3 to a wireless network access device in accordance with a first embodiment of the present invention;

FIG. 5 is a schematic view of an emitting device in accordance with a second embodiment of the present invention; and

FIG. 6 is a schematic view of an emitting device in accordance with a third embodiment of the present invention.

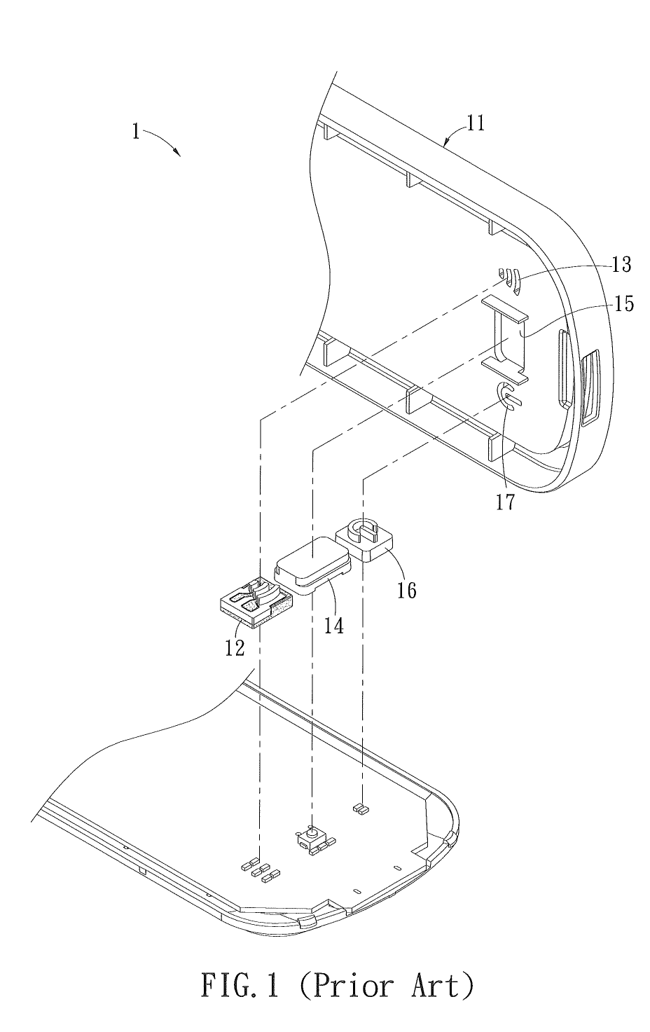

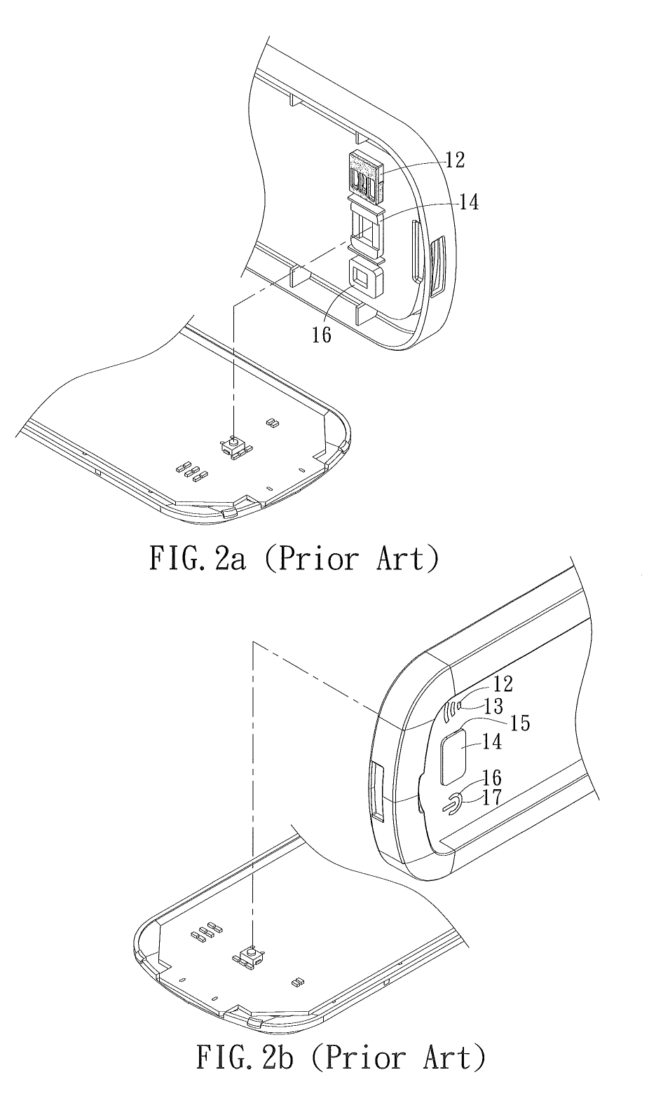

### DESCRIPTION OF THE EMBODIMENTS

Other features and advantages of the present invention will become apparent in the following detailed description of the embodiments with reference to the accompanying drawings.

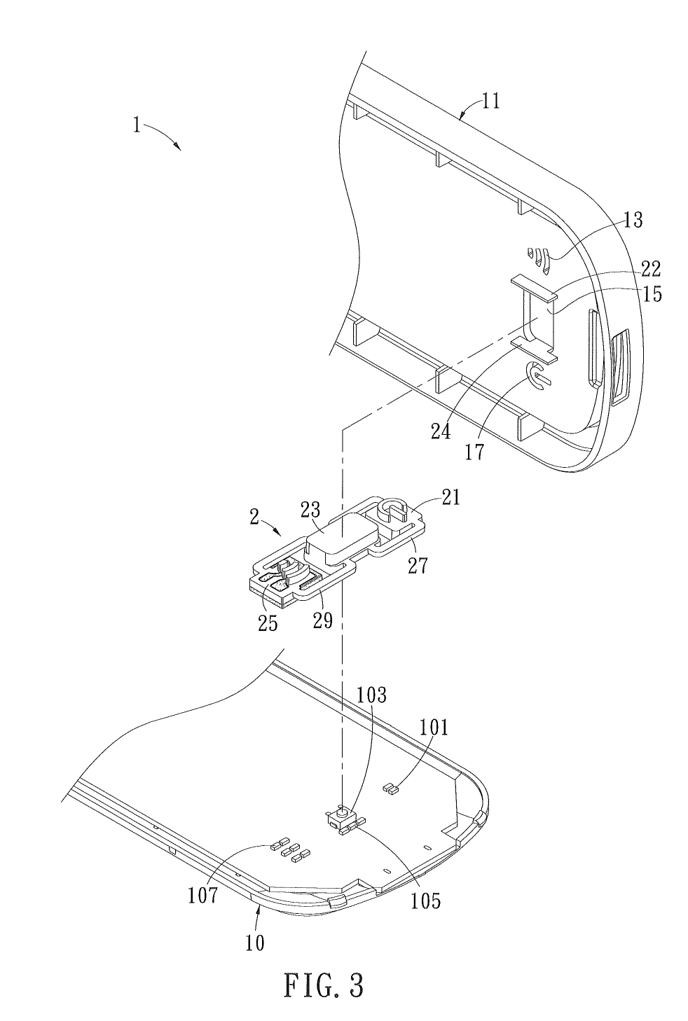

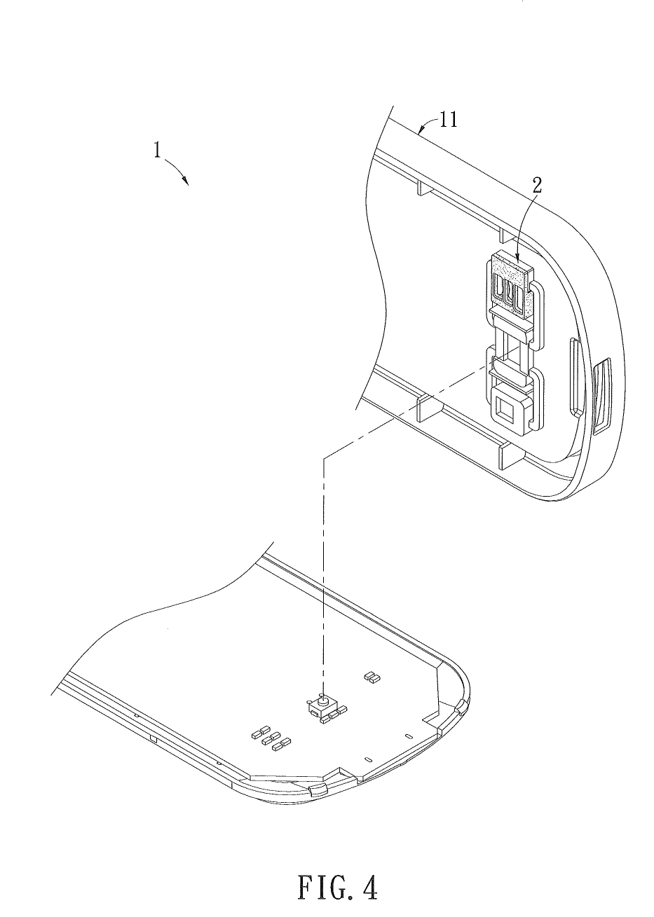

With reference to FIGS. 3 and 4 for an exploded view and a schematic view of an emitting device in accordance with a first embodiment of the present invention respectively, the emitting device 2 of this embodiment is applied to a communication product such as a wireless network access device 1, wherein same numerals shown in the figures are used for representing same elements, but not intended to limit the present invention.

The wireless network access device 1 (which is a communication product) includes a casing 11 and a first embedding portion 13, a second embedding portion 15 and a third embedding portion 17 disposed on the casing 11. Although the wireless network access device 1 of this embodiment has three embedding portions, other embodiments having different numbers of embedding portions disposed at different positions can be adopted. In the meantime, the wireless network access device 1 of this embodiment has a casing 10 (or a first casing) and another casing 11 (or a second casing) engaged with the casing 10, and the casing 10 sequentially installs a first light source 101, a switch 103, a second light source 105 and a third light source 107. The first light source 101, the second light source 105, and the third light source 107 can be light emitting diode (LED) lamps, wherein the switch 103 is disposed on a side of the second light source 105.

The emitting device 2 comprises: a first emitting portion 21, a second emitting portion 23 and a third emitting portion 25 provided to be embedded into the first embedding portion 13, the second embedding portion 15 and the third embedding portion 17 respectively, and for partially exposing the first embedding portion 13, the second embedding portion 15, and the third embedding portion 17 from the casing 11; and the first connecting portion 27 and the second connecting portion 29 are disposed at the first emitting portion 21 and the second emitting portion 23 respectively, such that each second connecting portion 29 is disposed on both sides of the second emitting portion 23 and the third emitting portion 25 separately. In this embodiment, the first emitting portion 21 is disposed at a position corresponding to the first light source 101, and the second emitting portion 23 is disposed at a position corresponding to the switch 103 and the second light source 105, and the third embedding portion 17 is disposed corresponding to the third light source 107.

It is noteworthy to point out that the emitting device 2 can include a plurality of emitting portions disposed at positions corresponding to the embedding portions respectively for embedding each embedding portion and partially exposing each embedding portion from the casing; and a plurality of connecting portions, each being coupled between two adjacent emitting portions, but the invention is not limited to the arrangement as disclosed in this embodiment only, but the number of the aforementioned structures of the present invention can be changed according to the number of embedding portions of the casing 11, and the modification can be achieved, and thus it will not be described here.

In this embodiment, the first emitting portion 21 is a power indicating portion, and the second emitting portion 23 is a press button, and the third emitting portion 25 is a signal indicating portion, and the first emitting portion 21, the second emitting portion 23 and the third emitting portion 25 are light guide structures made of a light guide material and used for transmitting the lights coming from the first light source 101, the second light source 105 and the third light source 107. When the second emitting portion 23 is a press button, and the thickness (or height) of the second emitting portion 23 is slightly greater than the first emitting portion 21 and the third emitting portion 25, such that the second emitting portion 23 can be protruded out from the second embedding portion 15 after the installation takes place, and the first emitting portion 21 and the third emitting portion 25 remain aligned evenly with the surfaces of the first embedding portion 13 and the third embedding portion 17.

Each of the first connecting portion 27 and the second connecting portion 29 is a connecting rod, wherein each first connecting portion 27 and each second connecting portion 29 are provided to be integrally, and respectively coupled to the first emitting portion 21 and the second emitting portion 23, and the second emitting portion 23 and the third emitting portion 25. Since the second emitting portion 23 is a press button disposed at a position corresponding to the switch 103 and the second emitting portion 23 is depressed slightly when it is pressed, therefore it is preferably to have an elastic deformation between each first connecting portion 27 and each second connecting portion 29 for pressing and restoring the position of the second emitting portion 23. Of course, the first emitting portion 21, the second emitting portion 23, and the third emitting portion 25 in other embodiments can be of other structures, and are not limited to those disclosed in this embodiment only.

In FIG. 3, a stop portion 22, 24 is disposed at the casing 11 and corresponding to on both sides of the second emitting portion 23 separately. Each stop portion 22, 24 is a stop block or a stop plate for blocking the light coming from the first light source 101, the second light source 105, and the third light source 107. For example, the light of an LED lamp has an angle of incidence approximately equal to 30° to 60°, and the height and length of each stop portion 22, 24 should be large enough to block the emitting light. However, the invention is not limited to those illustrated in the figures only. Although the stop portion 22, 24 of this embodiment is disposed at the casing 11, each stop portion 22, 24 may be disposed at the emitting device 2 instead, and a dual color injection molding technology and different colors and/or different plastic materials can be used for integrally forming the stop portion 22, 24 at the emitting device 2, such as connecting the stop portion 22, 24 to both sides of the second emitting portion 23, and the stop portion on the emitting device 2 can be an opaque stop block or stop plate. Since these elements can be implemented easily by the persons ordinarily skilled in the art, therefore, they are not illustrated in the figures.

Of course, the aforementioned dual color injection molding technology can be used for designing a dual color mold, therefore, at least one selected from the first emitting portion 21, the second emitting portion 23 and the third emitting portion 25 is a dual color emitting portion for improving the production capacity and efficiency.

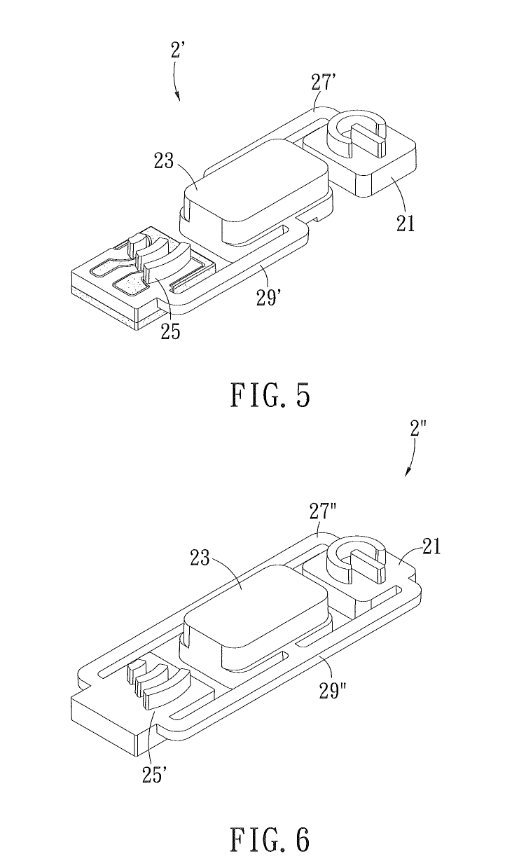

With reference to FIG. 5 for a schematic view of an emitting device in accordance with a second embodiment of the present invention, wherein the numerals used in this embodiment are the same or similar to those used in the first embodiment for the same elements, and the detailed description is omitted here.

In the emitting device 2′ of this embodiment as shown in FIG. 5, the first emitting portion 21, the second emitting portion 23 and the third emitting portion 25 are installed sequentially, and a first connecting portion 27′ is coupled between the first emitting portion 21 and the second emitting portion 23, and a second connecting portion 29 is coupled between the second emitting portion 23 and the third emitting portion 25. Unlike the first embodiment, the first connecting portion 27′ and the second connecting portion 29′ are disposed on different sides of the emitting device 2′ respectively. The first connecting portion 27′ and the second connecting portion 29′ of the present invention are designed to integrally couple to the first emitting portion 21, the second emitting portion 23 and the third emitting portion 25 in such that a desired flexibility for deformation can still be maintained at the second emitting portion 23, therefore, the emitting device 2 of this embodiment can save materials over the first embodiment.

With reference to FIG. 6 for a schematic view of an emitting device in accordance with a third embodiment of the present invention, the numerals used in this embodiment are the same or similar to those used in the first embodiment for the same elements, and the detailed description will be omitted here.

In FIG. 6, the difference of this embodiment from the first and second embodiments resides on that the first emitting portion 21, the second emitting portion 23, and the third emitting portion 25′ are installed sequentially, and a first connecting portion 27″ is disposed on a side of the first emitting portion 21, the second emitting portion 23 and the third emitting portion 25′, and a second connecting portion 29″ is disposed on another side of the first emitting portion 21, the second emitting portion 23 and the third emitting portion 25′.

In the meantime, each connecting portion of the first and second embodiments is installed separately, and the first connecting portion 27″ and the second connecting portion 29″ of the third embodiment are partially coupled with each other. In addition, the third emitting portion 25 of the first and second embodiments is a dual color emitting portion, but the third emitting portion 25′ of the third embodiment is not a dual color emitting portion.

It is noteworthy to point out that the connecting portion in accordance with the foregoing embodiment is disposed proximate to each emitting portion for saving the space of installing components in the casing, but the persons skilled in the art should have known that the present invention is operable well provided that each connecting portion is coupled to each emitting portion and a gap is maintained from each emitting portion. The shape and the quantity of connecting portions and the distance between each connecting portion and each emitting portion can be changed according to the required layout and actual needs.

In summation of the description above, the present invention uses a plurality of connecting portions for connecting scattered components to form an integrated emitting device, so as to overcome the issue of the complicated assembling process by simplifying the complicated process to a single assembling step without the need of positioning different components one by one. The invention can achieve the effects of reducing the manufacturing time of the products to be remained on a production line, shortening the assembling time, improving the yield rate, and lowering the rework cost. In addition, the present invention designs a single mold for the mass production, and saves the cost of the molds adopted by the prior art and provides a cost-effective application.

While the invention has been described by means of specific embodiments, numerous modifications and variations could be made thereto by those skilled in the art without departing from the scope and spirit of the invention set forth in the claims.

What is claimed is:

1. An emitting device, applied to a communication product having a casing and a plurality of embedding portions disposed at the casing, and the emitting device comprising:
a plurality of emitting portions, disposed at the embedding portions respectively for embedding each embedding portion and partially exposing each embedding portion from the casing; and
a plurality of connecting portions, each being coupled between two adjacent emitting portions.

2. The emitting device of claim 1, wherein each connecting portion is a connecting rod.

3. The emitting device of claim 1, wherein the first emitting portion, the second emitting portion and the third emitting portion are installed sequentially, and at least one first connecting portion is coupled between the first and second emitting portions, and at least one second connecting portion is coupled between the second and third emitting portions.

4. The emitting device of claim 3, wherein two first connecting portions and two second connecting portion are provided, and each first connecting portion is disposed separately on both sides of the first and second emitting portions, and each second connecting portion is disposed separately on both sides of the second and third emitting portions.

5. The emitting device of claim 3, wherein the first emitting portion, the second emitting portion and the third emitting portion are installed sequentially, and a first connecting portion is coupled between the first and second emitting portions, and a second connecting portion is coupled between the second and third emitting portions.

6. The emitting device of claim 5, wherein the first connecting portion is disposed on one side of the first and second emitting portions, and the second connecting portion is disposed on one side of the second and third emitting portions.

7. The emitting device of claim 6, wherein the first connecting portion and the second connecting portion are disposed at different sides of the emitting device respectively.

8. The emitting device of claim 3, wherein the first emitting portion, the second emitting portion and the third emitting portion are installed sequentially, and a first connecting portion is disposed on one side of the first, second and third emitting portions, and a second connecting portion is disposed on another side of the first, second and third emitting portions.

9. The emitting device of claim 3, wherein at least one of the first emitting portion, the second emitting portion and the third emitting portion is a dual color emitting portion.

10. The emitting device of claim 3, further comprising a stop portion coupled to both sides of the second emitting portion.

11. The emitting device of claim 1, wherein each connecting portion is integrally coupled to each emitting portion.

12. The emitting device of claim 1, wherein each connecting portion is partially coupled.

13. The emitting device of claim 1, wherein each connecting portion is separated.
